(19) United States
(12) Patent Application Publication
(10) Pub. No.: US 2007/0188501 A1
(43) Pub. Date: Aug. 16, 2007

(54) Graphical computer simulation system and method

(76) Inventors: Yangli Hector Yee, Las Vegas, NV (US); James Richmond, N. Las Vegas, NV (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 11/698,509

(22) Filed: Jan. 25, 2007

Related U.S. Application Data
(60) Provisional application No. 60/763,335, filed on Jan. 30, 2006.

(51) Int. Cl. G06T 15/70

(52) U.S. Cl. 345/473

(57) ABSTRACT

A system and method for creating real-time cinematic presentations and experiences of variable duration from unscripted content in interactive or non-interactive graphical computer simulations or environments, such as in strategy games in which enemy armed forces are aligned and fight against each other in battles.

### CROSS REFERENCE TO RELATED APPLICATION

This application claims the benefit of U.S. provisional patent application 60/763,335, filed Jan. 30, 2006, the entire disclosure of invention of which is incorporated by reference as if fully set forth herein.

### FIELD OF INVENTION

The present system and method relate generally to the field of computer graphics, more specifically to the placement and control of viewpoint sequences within an unscripted graphical computer simulation or environment for the purpose of generating cinematic depictions of events occurring in the simulation or environment to achieve a cinematic presentation and resulting a viewing experience of variable duration. The system and method provides for the autonomous, real-time construction of such sequences. These sequences are dynamic because the events they depict continuously change in real time as the method operates. The specification herein describes the system and method in the context of a specific war game application in which combat units of enemy armed forces can be made to engage in a simulated war by fighting battles against each other in simulated battlefield environments.

As used herein the term cinematic presentation refers to and means a presentation similar to the presentation of a motion picture, i.e., a presentation of video and, optionally, with audio of dynamic simulations. This presentation provides a cinematic experience that is like the experience a person has when watching moving pictures, i.e., watching movies. This in turn means that the cinematographer or some other entity such as the director or producer controls what is seen in the movie, rather than the person who watches the movie. In a cinematic presentation, the scene, viewpoint and special effects, such as shakes, zooms, pans, surround sound, etc., are not controlled by the viewer. Rather, some other entity, such as the cinematographer in a movie controls these attributes of the movie, and the computerized algorithm and/or the game designer controls these attributes in the present system and method. Within the context of the present inventive system and method, a cinematic presentation and experience relating to the graphical computer-created simulation occurs by watching the moving pictures on a computer display monitor, or some other display in which the graphical simulations may be seen by a person viewing the display. For any specific cinematic presentation generated in accordance with the principles of the present system and method, the cinematic experience of a particular viewer may be different for different viewers, much like a specific movie might provide a different experience to different viewers. A small child will have a viewing experience different than an adult watching the same movie, and different users of the present system and method will have different viewing experiences when viewing the same cinematic presentation.

Also, as used herein the term sequence refers to a series of pictures, or simulations of a series of pictures, taken from a camera, for a period from a starting time to an ending time. The sequence may be accompanied by an audio presentation. The sequence is typically a series of simulations of pictures that illustrate action related to a unit in a graphical computer simulation. Each picture may also be referred to as a “shot”. Each shot is shown as if taken from a camera, and depicts the action as would be seen from the camera's viewpoint.

### BACKGROUND OF INVENTION

Interactive and non-interactive graphical computer simulations or computer-created environments have long used two methods to incorporate cinematography into the presentation of the simulation: pre-rendered movies and/or scripted commands. Both of these known methods produce cinematic sequences of fixed duration and rely on fore-knowledge of the objects and/or events that will take place within the simulation or computer-created environment in order to achieve the desired cinematic presentation or experience. Neither of these conventional methods results in cinematic presentations or experiences with an unscripted graphical simulation as it runs in real-time.

Numerous conventional computer implemented software games are commercially available and include simulated actions that are viewed in real time but not cinematically. Such conventional applications include, but are not limited to the following examples: Dune 2; the Command & Conquer Series; the Warcraft Series; Starcraft; the Age of Empires Series; the Half-Life Series; Need for Speed Series and Burnout Series. The first five games mentioned are of the real time strategy genre, as are the preferred embodiments described below. These are games that depict a battlefield and battles between and among multiple units. The Half-life series is of the genre of first person shooters, where the user controls a single unit running on a battlefield. The remaining games mentioned are car racing games.

Dune 2 is published by Westwood Studios, and has a user-controlled camera that moves in two dimensions in a plane parallel to the plane of the battlefield, but with a fixed orientation or viewpoint and no real-time cinematic presentation or experience.

The Command & Conquer series by Westwood Studios includes in-game cinematic presentations that are pre-rendered offline using a third party rendering engine and then compressed and stored as a movie file. This differs from the present system and method in that the pre-rendered cinematic presentations are completely pre-scripted for everything—lights, cameras and animations for the units. In addition, the renderings of the images are done outside of the game software and in advance on a computer cluster and not in real time on the user's computer.

The Warcraft and Starcraft series by Blizzard Entertainment improves upon the Dune 2 a system by including real-time, pre-scripted real time cinematic presentations in which the sequences are pre-constructed in advance by the game designer. Both the units and camera movements are scripted by game designers in advance and are not generated on the fly as in the present system and method.

The Age of Empire series by Ensemble Studios has camera features similar to that found in Warcraft, but also allows the user to zoom in and out of the battlefield to a limited degree.

The Half-Life series by valve differs from the above-mentioned games in that it is in the genre of first person shooter games as opposed to real-time strategy games. In this game, the user plays a solider running around on a battlefield. The camera is tethered to the user's character as it runs around in the battlefield. This camera mode differs from the present system and method in that it is user controlled and not autonomous. It also depicts the view from a first person compared to a cinematic view.

The Need for Speed and Burnout series are a collection of car racing simulators developed by Electronic Arts. The technique used in these games is tethering a camera to the car as it races around on the racetrack or on city streets. Occasionally, when there is a car crash, the camera switches dynamically to a sequence of third person views depicting the accident. The present system and method autonomously picks interesting events to view and is of potentially unlimited duration, whereas in the Need for Speed/Burnout Series the depiction is pre-scripted and only occurs for the duration of a car accident.

Conventional cinematographic techniques used in graphical computer simulations are described in “Real-Time Cinematography for Games” (2005) by Brian Hawkins, ISBN 1-58450-308-4. Conventional techniques deal more with the placement of the camera in the scene and the framing of the scene rather than picking objects in the scene to look at. For example the paper “Planning Tracking Motions for an Intelligent Virtual Camera” by Li and Yu in Proc. IEEE Int. Conf. on Robotics and Automation, (May 1999), pp. 1353-1358 is believed to represent the state of the art in autonomous cinematography and describes the placement of a camera inside a virtual environment tracking one moving object, but not the picking and tracking of multiple moving objects as in the present system and method.

In unscripted graphical computer simulations it is often desirable to cinematically depict the most interesting aspects of what is occurring within the simulation as it occurs in real-time. For, example, in a computer simulation of battles in a war, it is desirable to depict that aspect of the battle that is most intense, or involves the most important objects, or units in the battle. As objects are added or removed from the simulation and interact with each other within the simulated environment, or interact with the environment itself, it becomes useful and advantageous to have a cinematic system that is not reliant on the existence of specific objects and events, and is not reliant on the existence of fore-knowledge of when, how or where these objects and events may occur. Pre-rendered movies and scripted sequences cannot capture and depict events cinematically as they unfold in an unscripted simulation. This is because in these known systems and methods the objects and events must be known quantities and must be of fixed number and duration, respectively.

Because pre-rendered movies and scripted commands cannot display what is currently occurring in an unscripted simulation in real-time, in order to view the simulation graphically, a viewpoint must be placed within the simulated environment. As used herein the term “viewpoint” means the view of a battle or of some other activity taking place in the simulation, as would be seen from a virtual camera. Examples of views that are contemplated to be within the scope of the present system and method include views seen by such a camera when it is stationary, zooming, shaking, rotating and/or otherwise moving relative to the environment and/or to the objects in the environment. The speed, frequency and other attributes of motion may be varied to achieve desired effects. Placement of a virtual camera in a scene in a graphical computer simulation in accordance with the present system and method is accomplished with conventional techniques.

In known systems and methods, in order to graphically display different aspects of a simulated battle or other activity as it takes place, one or more viewpoints are placed under the control of the viewer, or user of the system. While conventional methods allow for viewing different areas or aspects of the simulation as it runs in real-time, none produces the cinematographic presentation or experience for the viewer that the pre-rendered movie or scripted command methods do. In sum and substance, viewpoints provided in conventional graphical computer simulations do not qualify as cinematic viewpoints because they do not produce a cinematographic presentation or experience from unscripted simulated battles or other actions.

What is needed is a system and method that produces an autonomous, cinematic presentation or experience of a simulated battle or of other actions in real time and of essentially an infinite number of variations. It is believed that no prior system or method permitted creation of such cinematic presentations and experiences. In short, prior art viewpoints are not dynamically generated cinematic viewpoints because they do not produce a cinematic presentation and experience from unscripted simulated battles or other actions. The present system and method address this need by autonomously determining the primary focus of attention for the viewpoint within the simulation at any given time, and continuously and autonomously deciding how the viewpoint should be positioned in order to produce a cinematic presentation and experience.

Prior art in picking locations on images that are of interest to the observer, such as “Spatiotemporal Sensitivity and Visual Attention for Efficient Rendering of Dynamic Environments” by Yee et al, (2001), ACM Transactions in Computer Graphics, that describes operating on image data to derive importance of locations on an image, and not mapping of abstract game data and deriving values for the importance of games.

Hence, it is believed that the present system and method are novel in that they are capable of providing cinematographic presentations and experiences in an unscripted graphical simulation, potentially of unlimited duration, as it runs in real-time

### SUMMARY OF THE INVENTION

The system and method described herein overcome the drawbacks of known graphical computer simulations by providing autonomous determination of the primary focus of attention for the viewpoint within the simulation at any given time during the simulation, and continuously and autonomously determining how the viewpoint is positioned in order to produce a cinematographic presentation and experience. In the present system and method it is the system itself that controls the viewpoint, rather than the viewer, user or creators of pre-scripted viewpoints or of pre-rendered movies.

In the presently described computer controlled cinematic event depiction system and method, interesting objects and/or events are selected autonomously to depict cinematically, in an unscripted graphical computer simulation, objects that may move arbitrarily or under human control or under computer control. Audio may also be presented in coordination with the dynamic depictions. Knowledge of what currently exists within the simulation (the objects or units, and the environment), what attributes the environment and each unique object in the simulation can and do possess, what qualifies as interesting within the simulation, and a programmed list of viewpoint positions, movements, and/or actions are used as inputs to the system and method.

The inventive system and method combine numerous features of user and computer controlled viewpoints along with the cinematically pleasing results of the pre-rendered movie and scripted command methods to create a real-time cinematographic presentation and viewing experience. They allow for the continuous generation of cinematic depictions of events occurring in the simulation for an controllable, unknown or potentially unlimited duration, potentially of an infinite number of variations, and with computer selection, i.e., autonomous, selection of interesting events and objects, along with computer creation and sequencing of cinematic viewpoints in an environment where the ongoing simulation is unscripted and the actions and interaction of the objects within the simulation are unpredictable. The system has the ability to respond to unknown events and in an environment where more than one human or computer may be controlling different parts of the simulation.

The present cinematic system and method enables a user to initially pick an interesting event that is occurring within the simulation. This is accomplished through a module referred to as the interest manager and that incorporates an algorithm described in detail below. In a video game the interesting event could be the destruction of an object in the environment, such as a combat unit, an object or unit being attacked or attacking another object or unit, an object or unit having some attribute being in proximity with an object or unit having different or similar attribute(s), an object or unit positioning itself somewhere in the environment, the creation or arrival of a new object or unit, or an object or unit performing a specific action, etc. Any number of interesting scenarios can be programmed for detection or observation. For each of these programmed interesting events a priority is determined, because it is likely that multiple events will occur within the simulation at the same time and that have the same degree of interest. It is therefore preferred that the priority of interesting events is determined on the basis of factors, or hierarchy that corresponds to types of events that humans find more or less interesting relative to each other. It is within the scope of the inventive system and method, however, to prioritize the events on other bases, as would be chosen by and would be within the ordinary skill of a game developer. For example, in a preferred embodiment, destruction of a combat unit, or some other object could be designated as more interesting than an object approaching another object. The way in which the degree of interest or priority is determined is based on a number of factors, referred to as saliency factors, or simply saliency of a given unit. On the basis of priority of interest, the present cinematic system selects the most interesting event in accordance with the principles and description of invention herein.

Once an interesting event has been selected by the system, information about the event is obtained. This information can vary from event to event depending on the type of event and/or the number of objects that comprise the event so long as the information is sufficient for the system to generate a cinematic depiction of the event. The event type and information about the objects or units that comprise the event are data then used by the system to create a cinematic depiction of the event. This cinematic depiction is accomplished through another module in the application, referred to as the cinematic manager.

As will be described in detail below with reference to specific examples, the coding for a cinematic event depiction contains information, or data that define(s) how the viewpoint will behave while viewing an interesting event. Some of the information that defines a cinematic event depiction is pre-programmed while some is obtained from the event data or determined randomly depending on what depiction is selected to view the event. For example, the viewpoint movement and placement, as well as the primary focus of attention, i.e., what the viewpoint will be focused on during the depiction, can be programmed in accordance with the present system and method as offsets to the object(s) or unit(s) that will be contributors to the event depiction. When a specific cinematic event depiction, such as a battle between enemy combat units, is selected by the system, the actual position(s) of the viewpoint and the primary focus of attention over time are determined by the system from data obtained from the interesting event manager. The present system and method also provide other information or data to define other aspects of the depiction, such as the duration of the depiction, how the viewpoint will transition within the depiction or from/to another depiction, the field of view at the viewpoint during the depiction, whether the viewpoint shakes or not, by being pre-programmed or by being determined randomly when the cinematic event depiction is initialized. The more cinematic event depictions that are defined for a specific application, such as a simulated war game, in accordance with the principles of the present invention, the more varied and unique the cinematographic presentation and experience will be.

When a specific cinematic event depiction is completed, through operation of that part of the system referred to as the cinematic manager, the present system preferably generates either another cinematic event depiction of the same interesting event, or a new interesting event and an appropriate cinematic depiction for the new event. The result is a series of sequences of cinematic event depictions that create a cinematographic presentation and experience that can continue until the user decides to stop the simulation or the simulation is ended. The reference to potentially unlimited duration refers to a user starting the cinematic depiction mode of operation in the simulation and not stopping that mode of operation. Thus, unlimited duration refers to absence of a time limit within the time when the simulation is running. If desired, the user can cause the simulation to concentrate on the current interesting event, thus causing the viewpoint to remain on the current event depiction. Also, the present system and method enables the user to cause the application to generate a new cinematic event depiction before the current one is completed.

These and other embodiments, features, aspects, and advantages of the present inventive system and method will become better understood with regard to the following description, appended claims and accompanying drawings.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 is a schematic illustration of a generic unit, camera and frame of reference for a preferred embodiment of the present system and method;

FIG. 2 is a schematic illustration of a generic flyby sequence of camera shots for use in a preferred embodiment of the present system and method;

FIG. 3 is a schematic illustration of a generic circle sequence of camera shots for use in a preferred embodiment of the present system and method;

FIG. 4 is a schematic illustration of a generic chase sequence of camera shots for use in a preferred embodiment of the present system and method;

FIG. 5 is a schematic illustration of a generic hardpoint sequence of camera shots for use in a preferred embodiment of the present system and method; and,

FIG. 6 is a schematic illustration of a generic frigate sequence of camera shots for use in a preferred embodiment of the present system and method.

### DETAILED DESCRIPTION

The foregoing aspects and features of the present system and method, as well as its attendant advantages will become more readily appreciated with reference to the following detailed description, taken together with FIGS. 1-6 of the accompanying drawings.

Preferred embodiments of the inventive system and method take the form of computer-implemented video games that improve over conventional real-time strategy games. For the purpose of the present invention, the term computer implemented means any system or platform that includes at least one central processing unit. For the purposed of the present invention the words simulation and game, and object and unit, camera and viewpoint are used interchangeably, respectively. In conventional real time strategy games the user is typically in control of armed forces that are at war with enemy armed forces. The armed forces typically are army, navy, air force or interstellar forces, each of which has a number of appropriate combat units, such as soldiers, tanks, ships, sailors, fantasy creatures, spacecraft, animals, robots etc. Each user will fight against one or more opposing armed forces that are controlled by the computer or other human players, preferably over a network. The user can direct each combat unit in the user's armed forces to perform actions such as moving, attacking or performing actions that require special abilities. Each unit has simple, autonomous artificial intelligence, such as moving from one location to another while avoiding obstacles and automatically attacking the nearest enemy. The user typically directs the units in a strategic manner. Once started, the game typically proceeds until one of the armed forces is victorious.

In conventional applications the user views the battle from above the battlefield from a camera that has limited capabilities, such as zooming closer to and farther from the battle, rotating and/or moving around in a plane parallel to the plane of the battlefield. Also, some conventional applications include pre-scripted or pre-rendered cinematic presentations.

However, in contrast, in one aspect of the present system the user may choose a mode in which a battle or other action is cinematographically depicted to produce the cinematic experience. This mode, referred to as the cinematic mode, is preferably activated or initiated by pressing a key or button on the user interface, pointing device or triggered by special events. Once activated, that part of the system referred to as the interest manager, and as described in detail below, picks an interesting unit or event to observe or depict. For the purpose of the present system and method the interest manager is a module of code that, given a listing of units or objects supported within the application, sorts them in accordance with an algorithm or formula. The algorithm determines values for each of a number of interest factors, referred to as saliency or saliency factors, and then computes a total value associated with the total or overall saliency or interest value of a particular unit at a particular time and location in the simulation. For convenience in explaining the system and its operation, arbitrary times will be referred to as T1, T2, T3, T4, T5 . . . to refer to specific times at which the system code generates specific values for the units and the events described and claimed herein.

Data generated by the interest manager about a highly salient unit or event is then passed from the interest manager to the cinematic manager. The cinematic manager is a module that constructs a single camera sequence for the most salient unit or event, and is described below in detail. The cinematic manager selects a template camera sequence and from this template sequence constructs a camera sequence depending on the type of unit or event. Each template camera sequence includes randomly generated parameters. Upon completion of the sequence the cinematic manager calls the interest manager for another salient unit or event. The cinematic manager executes the sequence using conventional techniques by generating key frames for camera position, orientation, target and zoom, and then interpolating the key frames for the entire sequence.

As a result of operation of the interest manager and the cinematic manager, dynamic, unscripted cinematic depictions of simulated battles or other actions are autonomously produced in real-time and with dynamic variance. In its most preferred form, the present system and method are directed to a computer implemented graphical simulation that includes modules of code that provide the novel functionality described herein. As referred to above, one module of code is referred to as the “interest manager”. A preferred example of this code is provided as Appendix 1. The interest manager code functions to sort a collection of pre-designated simulation units into a listing having a particular order or priority, generated in accordance with an algorithm. As also referred to above, another module of code used in the present system and method is referred to as the “cinematic manager”. A preferred example of the cinematic manager code is provided as Appendix 2. The cinematic manager code functions to construct a single camera sequence for the most salient unit or event, as described in detail below. How the list of interesting events is generated and then how this list is used to construct the camera shots for the system is described as follows.

The Interest Manager

The interest manager functions to pick or select out of the universe of simulation units those units that are sent to the cinematic manager. As a result of this selection process a list of interesting events is constructed. Each interesting simulation unit or simulation event, and its priority in the list are picked autonomously by the computer in accordance with the interest manager algorithm or formula. The algorithm or formula is based on evaluation of a number of criteria within a range of criteria corresponding to the then existing environment of game play. By then existing, the specific, arbitrary times T1, T2, T3, etc. within a variable duration are referred to. In the preferred embodiment, the user chooses the start time, end time and thus the duration of the cinematic presentation. In a preferred embodiment an interest value, Iᵢ, is calculated at each of many specific times during the duration of the presentation for each unit “i” in accordance with the formula below:
Iᵢ=Σw(i) s(i)ⱼ,
where
w(i)ⱼ=weight of each unit I's saliency characteristic j,
s(i)ⱼ=saliency value of for each saliency characteristic j of each unit i,
   In the presently described embodiment, the criteria or characteristics, j, selected for saliency values of each simulation unit I are size, attack power, position, current health, number of targets that unit is attacking and is attacked by, the speed of that unit and a game designer specified cinematic importance value.

In this embodiment, size is defined as the size of the unit in game units, which is conventionally and typically the length of the diagonal its bounding box, as would be understood by a person skilled in this field. Larger sizes represent more saliency, and it is the game designers who typically determine the size of each simulation unit. Attack power is a value that is typically assigned by the game designers and is typically a numerical value corresponding to how much damage a particular unit can cause to other units or to the environment. Higher numerical values represent greater attack power and more saliency. As used herein the term position means the position of the unit in the environment of the simulation, typically a position on a battlefield. The position is specified by an offset from a fixed origin. In the present embodiment the origin is chosen to be the position that is the average of the positions of all units. The smaller the distance of the selected unit to the fixed origin the greater its saliency. This factor weighs the units near the center of the action, such as a battle, as having greater saliency. Current health is defined as how much health or fitness a selected unit has. A health value of zero indicates that the unit has been destroyed. In the present embodiment, the lower the health value of a unit, the greater is its saliency. This factor draws attention to units that are about to be destroyed or are under heavy attack and have been injured. The number of targets being attacked by a selected unit and the number of targets attacking that unit is preferably a numerical count of the targets that the unit is currently attacking summed with the number of enemy units attacking that unit. In the preferred embodiment the target saliency factor is proportional to this sum. The speed of a unit is the current speed of the unit as it is moving around in the simulation, typically moving around in a battlefield. A higher speed represents greater saliency. Finally, it is the game designers who typically would be expected to specify a cinematic importance value to give, for example, greater importance to hero units. A higher value of cinematic importance represents greater saliency.

During operation of a simulation, and for a given unit, the various saliency component values are computed and stored in a list by the interest manager. In the presently described embodiment, the preferred unit saliency calculation is performed as follows. First, the average, minimum and maximum value of each saliency is calculated for each saliency type, and the corresponding saliency is then normalized to a value between zero and one. For example, if the minimum speed of a unit has a value of 5 and the maximum value of its speed is 100, then the normalized speed saliency for that unit is determined by the formula:
(speed saliency−5)/(100−5)

By this formula, a speed value of 100 is mapped to the value I and a speed value of 5 is mapped to the value 0.

In general, the size, attack power, target and speed saliencies are determined and normalized to a value from 0 to 1 as follows:
New value=(current value−minimum value)/(maximum value−minimum value)
This formula is used in schemes or for components in which larger values indicate greater importance.

In contrast, and by example, in the preferred embodiment, health saliency is normalized to a value from 0 to 1 as follows:
New value=1−((current value−minimum value)/(maximum value−minimum value))
This formula is used in schemes or for components where smaller values indicate greater importance.

In yet another aspect of the system, the position saliency is normalized to a value from 0 to 1 as follows:
New value 1−absolute value ((current value−average value)/(maximum value−minimum value))
This formula is used when it is desired to place greater importance to units or events that have values closer to the average of all relevant or corresponding values.

Using the above series of formulae, the saliency values for all units are normalized to a value from 0 to 1, with 0 being less important and I being more important. As may be appreciated, various schemes for determining saliency factors, and assigning values and normalizing saliencies may be used in designing graphical computer simulations. Here, by application of the above series of formulae to the units in the simulation, presentation of units is intended to be made to correspond to naturally occurring selection behavior of humans when there eyes are met with competing visual signals, as has been termed “center-surround” or “normalization” in visual attention literature.

In another aspect of the interest manager module, the preferred algorithm functions to diminish the significance of large signals that are found in the presence of other, similar signals. For example, a black square in a checkerboard is less noticeable to a viewer than is a black square on a white piece of paper, due to the lateral inhibition of the signal. The lateral inhibition value is determined by computing an approximation value, i.e., the difference between the minimum and maximum values for each saliency type, and then multiplying the saliency value by that difference. For example, the new speed saliency calculated to account for lateral inhibition would be calculated as follows:
New speed saliency=speed saliency*(maximum speed saliency−minimum speed saliency)
With respect to the above speed saliency calculation, suppose all of the units in the simulation were traveling at approximately the same speed. Then the difference between the maximum and minimum speed saliencies would be small. This small difference multiplied by the speed saliency would serve to diminish the overall speed saliency for all of the units and operate to result in increased relative saliency values for other saliency factors that have a greater difference or spread, such as attack power or size.

Next, in the presently described embodiment, the individual saliency factors for each unit are multiplied by weights and summed. The weights are determined by the game or simulation designer(s), and as may be appreciated, can be varied to achieve desired end results. The final, summed value represents the importance of the given unit under consideration. The larger the numeric value the more important is the unit. In the presently most preferred embodiment, the weight factors are set to have the following values:
Size weight=1.0
Power weight=1.0
Position X weight=0.5
Position Y weight=0.5
Health weight=1.0
Target weight=1.5
Speed weight=1.0
Cinematic weight=2.0
   As expressed in the algorithm above in formula form, the importance of the unit is the sum of the product of weight value and its saliency (weight x its saliency) for each of the chosen saliency characteristics.

The importance of each unit is calculated and then a list is made of each unit and its corresponding importance. Next, the algorithm sorts the list in descending order of importance. The interest manager then truncates the list, at some designated number, which for the presently most preferred embodiment is 10. As may be appreciated other numbers and ways of chosing or deciding how to truncate the list may be selected. In the preferred embodiment one unit from the list of 10 is selected for observation. In its present form, the preferred selection process is by random selection. Also, as may be appreciated, other ways of choosing the unit for observation may be used. For example, the unit having the highest importance value could be chosen for observation.

In one aspect of the preferred embodiment, if the unit so selected is the same unit as the previous unit under observation, then some other unit from the top 10 in the list is chosen for observation. This preferred aspect of the system prevents repeated viewing of the same unit.

Although specific embodiments of the invention have been described, various modifications, alterations, alternative constructions, and equivalents are also encompassed within the scope of the invention.

In another preferred embodiment, the interest manager algorithm is set to observe the target of the currently observed unit at some probability of its being randomly selected as the next unit. For example if the target of the currently observed unit is selected to be the next unit for observation, then a 66% probability factor could be used to result in that unit being observed at two thirds of the time that situation arises. Such an adaptation to the system would tend to lend a measure of coherence to the camera sequencing.

In accordance with the present system the user may control one or more units engaging in battle by selecting them on the screen and issuing commands to them. It is preferred that the very first camera shot will be a user-selected unit as its object of focus. The interest manager would then proceeds to pick the next interesting object to look at based on predetermined event triggers, such as, for example, hero battles, death of hero objects, bombing runs, etc. In the absence of any predetermined event trigger, then a list of salient units is generated by the algorithm and passed on to the cinematic manager for creating a camera sequence for the selected interesting object.

Appendix 1 is a listing of source code that performs the functions of the interest manager, written in the computer language C++, the computer language used to implement the preferred embodiment. The “interest manager” is implemented as a stand alone module called the InterestManagerClass with portions of code residing in the CinematicsManagerClass:: Pick_Next_Interesting_Object( ).

The responsibility of the InterestManagerClass is to create a sorted list of “GameObjects”, i.e., units and hardpoints on a given unit, such as a gun turret on a ship, by importance. Each unit and hard point corresponds to a GameObjectClass C++ Object.

The function InterestManagerClass::Create_Interesting_List sorts the game objects in the list “objects” by importance and stores it in the list InterestManagerClass::Interesting.

The function InterestManagerClass::Get_Interesting_List returns the sorted interesting object list InterestManagerClass::Interesting to code modules interested in the list.

The function InterestManagerClass::Compute_Targets computes the number of units targeting a particular unit and stores it in the hash map InterestManagerClass::Targets. This allows the code to rapidly compute the number of units targeting the unit currently being inspected by the code.

The structure InterestManagerClass::SaliencyStruct stores the Importance and Saliency values computed for each game object Obj.

The bulk or major part of the implementation of the interest manager is found in the function InterestManagerClass::Create_Interesting List. Operation of this preferred algorithm begins by retrieving the saliency weights for each saliency channel of size, power, position, targets, health, speed and game designer specified cinematic saliency. Next, the minimum (smin), maximum (smax), average (savg) and one over the difference between minimum and maximum (sscale) of each saliency channel is set to appropriate default values. The target hash map, mapping each game unit to the number of units targeting it, is then computed, by applying Compute_Targets to each object in the list of candidate game units “objects”. A series of game specific filters are then applied to the list “objects” to obtain the list of important object candidates “importance”. Units that are hidden by the Fog of War device, i.e., a game device mimicking the unknown where units that have not been seen or are out of sight are considered ‘fogged’, are filtered out. Units that are hidden by game code or are dead or are parts of buildings or behave like transports or other attributes considered unimportant are filtered out through conventional techniques. Hard points are also filtered out for the reason that they are GameObjects that are parented or tied to other GameObjects. The SaliencyStruct for each object is then filled out with the raw data for each unit such as its size, power, position, health, targets and cinematic values. The list of SaliencyStruct data for each unit is joined together in the list “importance”. The statistics for each saliency channel such as the average (savg), scale (sscale), minimum (smin) and maximum (smax) values are also computed. Next, the list of “importance” is iterated and the saliency values for each unit is normalized within the range (0, 1). Lateral inhibition is then performed for each saliency value by multiplying by the difference between the largest and smallest saliency value for each saliency attribute. Finally the importance of each unit is calculated as the weighted sum of saliency weights and saliency values. The list “importance” is then sorted and stored in the variable InterestManagerClass::Interesting for future retrieval.

In the preferred embodiment, the function CinematicsManagerClass::Pick_Next_Interesting_Object( ) is used by the Cinematics Manager to pick the next interesting object to view. It maintains the variables CurrentInterestingObject, CurrentInterestingType and CurrentInterestingHardpoint which are pointers to the unit, the unit's template type and the hardpoint (if any) on the unit that is of interest. The unit's template type differs from the unit in that a unit is an instance of the unit template type. For example “Soldier0” and “Soldier1” are both units that are derived from the template “Soldier”, i.e., each shares common characteristics such as model geometry (stored in the template), but differ in other characteristics such as world position (stored in the unit). The hardpoint is a game object whose parent is the current unit. It could be, for example, the gun turret (hardpoint) on a battleship (the current unit). The algorithm operation begins by seeing if the CurrentInterestingObject has a target and a random number generated between 0 and 2, inclusive. If the random number is greater than zero and the current object is alive and has a target, then the target is chosen to be the next interesting object, otherwise the list of all units in the game is generated and filtered so that unimportant objects such as walls and building chunks are excluded. These candidate units are stored in the list “objs” and handed over to the InterestManagerClass::Create_Interesting_List for processing. In the preferred embodiment, the interesting object list is scanned for units of “supreme cinematic importance”, which are flags that can be set by the designer through use of conventional techniques. These flags are preferably reserved for heroic units. If no supremely important unit is found, a unit that has a type different from the previous object is randomly selected from the top 10 most interesting units. Finally, if the unit has a hardpoint, the hard point is used with 75% probability in the preferred embodiment. Other probability values can, of course, be chosen and used by the game designer(s).

The above description of preferred algorithms for use in the interest manager show how each of a series of specific units in the simulation can be picked or chosen to be observed or viewed in the live battle or other live action to be cinematically depicted in the simulation.

The Cinematic Manager

Once a unit has autonomously been selected by the interest manager, as described above, the data associated with the chosen unit is passed from the interest manager to the cinematic manager. The cinematic manager is a module that constructs a single camera shot sequence for the most salient unit or event. Specifically, the cinematic manager selects a template camera shot sequence and from this template sequence constructs a camera shot sequence depending on the type of unit or event. Each template camera shot sequence includes randomly generated parameters such as shot duration, camera positioning and orientation. The cinematic manager executes the sequence using conventional techniques by generating key frames for camera position, orientation, target and zoom, and then interpolating the key frames for the entire sequence. Upon completion of one sequence the cinematic manager then calls the interest manager for another salient unit or event, the interest manager selects, in accordance with the algorithm describe above, another unit for observation, and then the cinematic manager generates and executes another shot sequence. A preferred cinematic manager is described in detail below, with reference to FIGS. 1-6.

FIG. 1 illustrates how a camera 20 is positioned with respect to a unit 22 such as tank or spaceship. The offset is then animated over the period of a shot to show the camera's viewpoint of the unit in a conventional manner. For example, given two key frames for the offset at time T=0 and T=1, the offset at any time T between T=0 and T=1 is an interpolation of the two key offsets and the corresponding viewpoint is the corresponding interpolated viewpoint. In addition, the camera's target can be specified independently of the camera's offset, with respect to the unit's reference frame. In this way depictions of a single unit are generated for any combination of camera and/or unit movement with respect to the other. Analogous depictions of multiple units may be created, in accordance with the principles of the present system and method and using additional conventional techniques. As shown schematically in FIG. 1, the orientation and position of each unit 22 can be described with a four-component vector, known as the offset. Origin 24, sets the unit's position in the virtual environment within a frame of reference 26, and forward, right and up components of the vector set the unit's position and orientation in a scene in the simulation, such as an orientation and position on a battlefield. A camera shot may be set up for each unit by animating the camera offset from the origin of the unit and described relative to the unit in the reference frame of the unit. An offset of (1, 2, 3) for example, means that the camera is located 1 in front of the unit, 2 to the right and 3 above the unit in game coordinates. Correspondingly, the target location of the camera may be specified relative to the unit in the same fashion. The present system and method may be used in coordinate systems that are relative as well as world absolute coordinates for the camera position and camera target. As is conventional, world absolute coordinates use the battlefield origin and the world X, Y and Z axis as the frame rather than unit location and unit frame. The present system and method also allow different units to be used to specify the camera position and the camera target. For example, the camera's position might be specified as an offset from a unit A, while the camera's target might be specified as an offset from a unit B. The camera offsets are stored in a spline, which refers to a conventional method for smoothly interpolating values using time as an interpolant. The system and method autonomously specifies the key frames with specific locations and specific times for the camera and the spline then interpolates the location from the current time in between the key frames, and this information in turn is used to generate the view of the unit displayed. The same method preferably is applied to the camera's target.

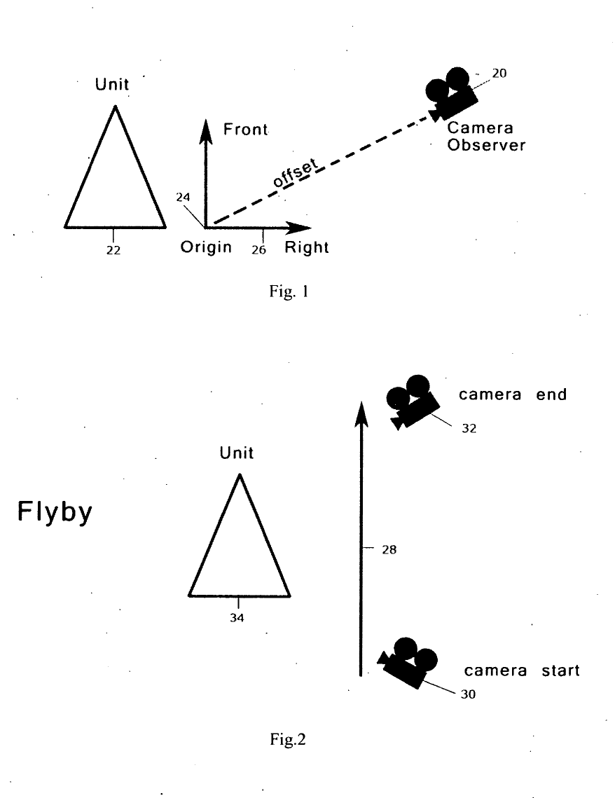

Using the same terminology and concepts as described with respect to FIG. 1, schematic views of other different, exemplary template camera sequences are shown in FIGS. 2-6. For example, FIG. 2 illustrates a flyby shot 28. The flyby shot is one in which the camera position begins behind the unit and ends up in front of the unit, with the camera target set to the unit's origin. The distance used is preferably a randomly chosen multiple of the unit's bounding box length.

In FIG. 2 the camera viewpoint at T=0 is shown at 30, and at T=1 at 32 in the direction shown by the arrow. In the flyby shot the camera moves in generally a straight line from one position relative to the unit 34 to a second position relative to the unit and at a speed much greater than the speed of the unit. In the flyby shot, the appearance to the viewer is much like the view that would be seen from an airplane flying by a stationary or slow-moving object. A flyby shot is a preferred for large units such as spaceships, and typically is not preferred for relatively small, human-sized units.

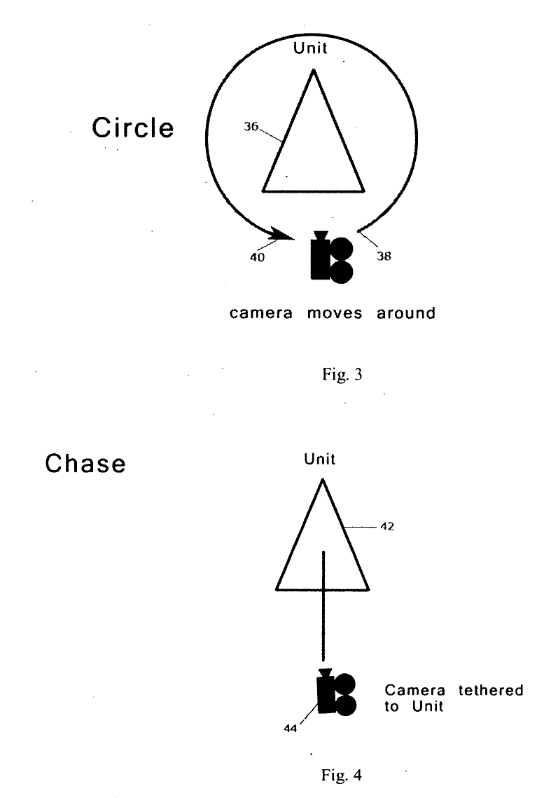

FIG. 3 is a schematic view of a basic, circle shot used to view each unit regardless of size. The circle shot is one in which the camera is always looking at the center of the unit and the camera's position rotates around the unit at, preferably, a radius that is a randomly chosen multiple of the unit's bounding box length. FIG. 3 shows a basic circle shot of unit 36 from a camera that is moved around the unit in a circle, with the beginning of the shot shown to start when T=0 at 38, and end when T=1 at 40 in the direction shown by the arrow. In accordance with conventional technology, basic shots can be transformed so that they are relative to each unit's reference frame and thus are able to be used in the simulation on any unit while the units are moving around in the scene.

FIG. 4 schematically illustrates a chase shot of unit 42 from the viewpoint of camera 44 shown directly in back of the unit. In general, a chase shot is one in which the camera follows the unit at a fixed distance, always looking just in front of the unit.

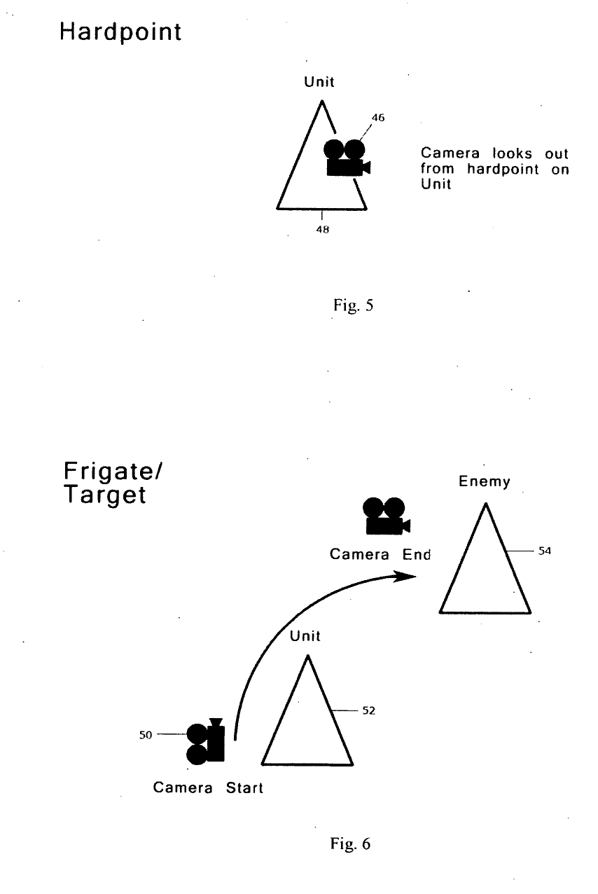

FIG. 5 illustrates a hardpoint shot with camera 46 positioned on unit 48 and with its viewpoint directed to some other unit or activity in the simulated environment. For example, a hardpoint shot could be one in which the camera is placed at a gun turret of a unit 46 at T=0, if it has one, looks out from there to the target of the turret until T=1 to observe the action taking place at the target.

FIG. 6 illustrates a frigate/target shot with camera 50 placed behind unit 52 and its viewpoint toward another unit 54, and then the camera is moved relative to the other unit 54 so that it ends up in front of the other unit and with its viewpoint pointed toward unit 52. For example, in a battle scene the camera 50 would typically begin at T=0 behind an attacking unit 52 and with its viewpoint toward a target unit 54. Camera 50 would then follow a path that ended in front of unit 52's target at T=1, i.e., the camera 50 transitions from the unit 52 in the beginning to the unit's target 54 at the end. During the camera's transition relative to the unit 52 and unit 54 the viewpoint of the camera 50 also transitions from the target unit 54 to the attacking unit 52.

Appendix 2 is a source code listing of the main components of the preferred embodiment cinematic manager described herein. The Appendix 2 code is in the computer language C++ and shows how the main components of the cinematic manager assemble each camera shot. Once the current interesting game object is picked by the interest manager, it is passed to the code referred to as CinematicClass::Init_Interesting_Object_Cinematic. This code provides the function that looks at the type of unit being observed and calls the appropriate camera shot function (code) to generate for the unit. Camera shots are then constructed by specifying keyframes for the position and orientation of the camera and the target location at which to point the camera. Keyframed interpolated animation of camera the camera shots is accomplished by conventional techniques.

In the preferred embodiment the keyframe data is represented by the structure PostionKeyFrame for position keys and ValueKeyFrame for other keys such as rotation. The important variable for a Position keyframe is the frame it occurs on “Frame”, the position data for that key. The position data will be “Position” if it is a position in the world, otherwise it will be “Offset” if the key is attached to a valid object of ID “AttachObjectID”. If the attached object has a hardpoint such as a weapon turret, the hardpoint is stored in “HardPointObject”. The preferred embodiment supports four kinds of transitions between key frames—spline, whereby the keyframes are interpolated using the spline specified in “SplineType”, linear, whereby the keyframes are linearly interpolated, cut, whereby the spline will hold on to the settings in the previous key, then jump to the next key when the frame of the next key has arrived and finally rotate, whereby the camera will rotate around the attached object using the variables “Frequency” and “Reverse”.

The preferred embodiment for keyframe interpolation uses Catmull-Rom, Cardinal or TCB splines chosen by the variable “SplineType” for interpolating data between key frames and is known by convention. The variables “Tangent”, “Tension”, “Continuity”, “Bias”, “EaseOut”, “EaseIn” all relate to the parameters of the interpolating spline and are known to those skilled in this field. Finally, the code referred to as “IgnoreAttachFrame” functions to allows the keyframed data to only use the “Offset” relative to the attached object, while ignoring the rotation of the object basis if the object rotates or changes heading. That is, if the camera starts out behind a unit, it will remain in the same position relative to the unit even if the unit turns left and/or right if “IgnoreAttachFrame” is set to true. If it is set to false, then the code will function as so that the viewpoint will be as if the camera was tethered to the unit by a rigid stick and will follow the unit if the unit turns left and/or right. This is disorienting if the camera is following a fast turning object like a fighter plane.

By convention in key framed animation, the camera position and target location are specified at specific frame numbers called key frames and the frames in between are calculated by interpolating between the bounding key frames. For example if there is a camera position key at T=0 and a camera position key at T=1, then the camera position at frame T=0.5 is calculated from the camera position at key frames T=0 and T=1. The code samples use a unit called frame which is T multiplied by frames per second (fps), which in the preferred embodiment is 30 frames per second.

The other attributes of the camera are also stored similarly in the ValueKeyFrame structure. These attributes may include the roll of the camera, which specifies how much a camera is rotated around the axis it is pointing to.

In the preferred embodiment, the following camera shots are generated: Flyby, Circle, Hardpoint, Chase, Frigate, Infantry, Vehicle, Building, Flying, Floating and Glory. The camera shots are generated by specifying position key frames for the camera relative to the unit being observed or relative from the battleground's origin at specific frames. Some parameters such as distance from the unit and orientation of the camera from the unit are randomly generated.

Init_Flyby_Cinematic. This portion of the source code corresponds to the flyby shot depicted in FIG. 2 and is used in the preferred embodiment for the cinematic depiction of large, capital spaceships. It is one of the default cinematic types that is used if there is no special case camera shot for a particular unit. The key framed camera animation is accomplished by conventional techniques. In this function, the bounding box of the unit is used to place the camera on one side of the unit, the side being picked randomly, or left under the unit with 50% probability, the latter being referred to as the “belly camera” mode. In the object's frame of reference, X points to the left, Y points to the rear and Z points up. Hence a frame offset of (x, y, z) means x units to the right, y units forward and z units above the unit. In the belly camera mode, the first frame, frame 0, is set to attach the camera to the unit, starting at the center line of the unit (x=0), 0.6 of its half-length to the front of the center of the unit and half its height below the center of the unit. The last camera frame is correspondingly set to 3 times the half length behind the center point of the unit and 1.5 times the half-height of the unit below the center point. In the “belly camera” flyby shot the duration of the shot is set to 8 seconds multiplied by 1+size, where size is smoothly interpolated from 0 to 1 based on where the length of the unit lies in the interval (30, 500). Thus, unit lengths of less than 30 map to the size value 0 and unit lengths of more than 500 map to the size value 1. In this manner, the length of the shot is varied from 8 to 16 seconds based on the size of the unit. The target for the camera is fixed to 6 times the half length forward of the unit.

The variable “IgnoreAttachFrame” means that only the position of the object the camera is attached to is used, and not its frame of reference should the unit rotate in the future. Because it is set to false, the key frame will rotate if the unit rotates over the course of the shot. This forces the camera to always look to the front of the unit, even when the unit is turning. Alternatively, the flyby could at 50% probability start on one side of the unit and sweep from front to rear while always looking at the center of the unit. The duration and the side to look at the unit from are picked randomly. As is readily apparent, the specific values chosen in the preferred embodiment can be varied according to the end result desired by the game or simulation designer, and all such variations are considered to be within the scope of the principles of the present system and method.

Init_Circle_Cinematic. This cinematic shot is depicted in FIG. 3 and is a fall back shot picked by the code referred to as CinematicClass::Init_Interesting_Object_Cinematic if no better cinematic shot is found for a specific unit type. It is commonly used for large spacecraft. In this function, the direction of rotation (clockwise or anti-clockwise) is preferably picked randomly at 50% probability and set to the variable “reverse”. The number of frames for this segment is set between 90 and 270 frames (3 to 9 seconds), depending on the relative size of the unit, in variable “segment”. The rotation speed is set to 600, which means that one rotation around the unit is performed every 600 frames. The camera's target is locked to the center of the unit for the entire duration of the shot.

Init_Chase_Cinematic. This camera shot is typically used for smaller units such as fighter planes or small, rapidly moving spacecraft and is depicted in FIG. 4. in the preferred embodiment this camera shot is constructed by choosing at 50% probability each of two different kinds of chase shots—one in which the camera stays on to the front or back of the unit and remains that way for the entire shot, or the other in which the camera starts from the front of the unit and drops back to the rear at the end of the shot. In the first variant, where “mode” is zero, the shot may last randomly between 2 and 4 seconds. It is preferably 6 units to the side of the unit, at an angle of between −45 to +45 degrees in front of the unit or at an angle of between 135 to 225 degrees at the rear of the unit. If “mode” is one, the camera starts out between 6 to 8 lengths of the unit in front and ends up between 2 to 4 lengths behind the unit.

Init_Hardpoint_Cinematic. This camera shot is preferably used for units that have hardpoints such as a tank's barrel or a weapon turret on a capital ship. The camera shot is depicted in FIG. 5. In the preferred embodiment the function begins by first checking if the target of hardpoint is hidden or fogged. If it is the function returns and the interest manager picks another unit to look at. If it is not, then, the camera is preferably tethered 200 units above the hardpoint and the shot is set to a duration of 60 to 90 frames.

Init_Frigate_Cinematic. This camera shot is preferably used for medium sized units that are bigger than the units typically depicted in the chase cinematic but smaller than the capital ships depicted in the circle cinematic. The camera shot is depicted in FIG. 6. Preferably, if the unit of interest does not have a target, the function returns and another unit is picked for viewing. Also, if the angle between the depicted unit and its target are far from being head on, the function aborts and another unit is picked for cinematic depiction. In the first part of the camera shot, the camera starts out between 1 and 7 lengths behind the depicted unit and looks at the depicted unit. In the second part of the camera shot, the camera ends up near the nose of the target unit of the depicted unit, with the target of the camera transitioning to view the front of the target unit of the depicted unit.

Init_Infantry_Cinematic. This cinematic shot is used for relatively small or human sized units like infantry. In the preferred embodiment the camera shot is set up so that it hovers over the left or right shoulder of the unit looking in the direction of the unit.

Init_Vehicle_Cinematic. This cinematic shot is preferably used for land vehicles such as tanks or cars. In the preferred embodiment, the camera shot begins at 5 times the half height of the unit and is clamped to a minimum of 50 units and a maximum of 125 units. The camera shot either moves from the front of the unit to its rear, or from its rear to the front or pans across the side of the unit with equal probability.

Init_Building_Cinematic. Preferably this cinematic shot is used for buildings or stationary objects such as weapon turrets and command centers, and the corresponding units are referred to as “building” units. In this function, the interest manager does not pick building units directly, but building units might be the target of the previously depicted unit and hence have a possibility of being a depicted object. This camera shot lasts between 60 and 90 frames and is simply the view of the building unit from one of the four corners of the bounding box of the building unit at a distance of twice the extent or length of the bounding box.

Init_Flying_Cinematic. Preferably this cinematic shot is used for props such as birds that have erratic behavior, such as the flying behavior of birds. This cinematic shot is different from the previous ones in that once the camera is placed in the shot, its position is not tied to the flying unit. It merely hovers in the place it was put, but it does turn to look at the flying unit.

Init_Floating_Cinematic. This camera shot is one in which the camera is preferably placed on a circle 2 to 4 times the extent or length or diagonal of the bounding box of the depicted unit and just remains there, much as in the flying cinematic shot, with the camera looking down upon the depicted unit at an angle of preferably between 20 to 45 degrees from the horizontal.

Init_Glory_Cinematic. This camera shot is one that is not entirely procedurally generated. In a preferred example, a template shot is constructed for a heroic unit in one reference space and then transformed by this function into the object space of the unit being depicted. The template shot contains the orientation and offset of the camera from a fixed target. The example code shown in Appendix 2 takes the offsets and uses them to calculate the key frames of where the camera should be, in game coordinates.

As described and shown schematically above, several examples of animated, unit relative shots are created, each of which has a duration measured by the difference between the ending time and the starting time, to form sequences of shots. The camera shots are chained together to form the sequence, with preferably a different unit picked as the object of each shot, or otherwise picked in accordance with the interest manager. A series of shots, as schematically illustrated in the figures, can be set up to be generic and can be used for any unit.

Thus, by combining the results of the interesting object manager with the results of the cinematic manager, a method of providing a cinematic system has been described. This cinematic system and method can be used in an environment, such as a dynamic battlefield where the future state and position of each of the units are not known in advance. The unit being looked at or observed may undergo motion, be still, or even be destroyed and its state and future position are dependent on what is happening in a game at the time that the viewer chooses to activate the system. Once activated the present system the creates and provides a cinematic presentation. Each such cinematic presentation will provide a cinematic experience for each viewer, with the experience varying according to the age and other characteristics and prior experience of each viewer. In accordance with the present system and method, the identity, states and future positions of the units observed during the cinematic experience are unpredictable.

The above specification and drawings are, accordingly, to be regarded in an illustrative rather than a restrictive sense. It will, however, be evident that additions, subtractions, deletions, and other modifications and changes may be made thereunto without departing from the broader spirit and scope of the system and method as set forth in the claims. For example, while the above embodiments have described the present system and method in the context of a video battle game, it is apparent that the system and method has application in many other graphical computer simulation contexts. For virtually any subject matter that can be made the subject of a motion picture, the present system and method can be applied or adapted to provide for a cinematic experience of a graphical computer simulation of that subject matter. The specific names, shapes, configurations and attributes for units; the specific actions taking place and the specific frame of reference will of course vary with the subject matter depicted in the simulation, but generating such specifics is considered to be within the scope of the present system and method, and its claims appended hereto.

What is claimed is:

1. A method for creating real-time cinematographic presentations of variable duration from unscripted content in an interactive graphical computer simulated war game comprising:
providing a plurality of units, each unit i of said plurality of units having an interest value, Iᵢ;
providing a plurality of saliency characteristics j, for each said unit i, each of said plurality of saliency characteristics j selected from the group consisting of size, attack power, position, current health, number of targets that each said unit i is attacking and is attacked by, the speed of each said unit I and a designer determined importance value, each saliency characteristic having a value, sⱼ for each unit i;
providing a weight value for each saliency characteristic j;
calculating at a first time during said variable duration, T1, the interest value, Iᵢ, associated with each of the units i in accordance with the formula
Iᵢ=ρw(i)ⱼs(i)ⱼ,
where
w(i)ⱼ=weight value of each unit i's saliency characteristic j, and
s(i)ⱼ=value of each characteristic of each unit i's saliency characteristic j;
creating a first priority list of interest values from the calculated interest value for each of the predetermined number of units at T1;
selecting one of said plurality of units for observation on the basis of its position in said first priority list to be a first currently observed unit;
constructing a first single camera shot sequence for said first currently observed unit;
displaying said first single camera shot sequence;
creating at a second time during said variable duration, T2, a second priority list of interest values with said formula and from the calculated interest value for each of the predetermined number of units at T2;
selecting a second of said plurality of units for observation on the basis of its position in said second priority list to be a second currently observed unit;
constructing a second single camera shot sequence for said second currently observed unit;
displaying said second single camera shot sequence; and,
forming a series of sequences at subsequent times T3, T4, T5 . . . , by repeating the creating, selecting and constructing steps to form said real-time cinematic presentations during said variable duration.

2. The method of claim 1 wherein w(i)ⱼ for each unit's saliency characteristic, j, is in a range of values, including:
Size weight value from 0.1 to 2.0;
Power weight value from 0.1 to 2.0;
Position X weight value from 0.1 to 0.9;
Position Y weight value from 0.1 to 0.9;
Health weight value from 0.1 to 2.0;
Target weight value from 0.1 to 2.5;
Speed weight value from 0.1 to 2.0; and,
Importance weight value from 0.1 to 4.0, respectively.

3. The method of claim 1 wherein each saliency characteristic, j, has a predetermined minimum value, a predetermined maximum value and a predetermined average value.

4. The method of claim 3 further including a step wherein each saliency characteristic, j, for size, attack power, target and speed saliencies for each unit, i, is normalized to a value from 0 to 1 in accordance with the following formula:
New value=(current value−minimum value)/(maximum value−minimum value).

5. The method of claim 3 further including a step wherein health saliency is normalized to a value from 0 to 1 in accordance with the following formula:
New value=1−((current value−minimum value)/(maximum value−minimum value)).

6. The method of claim 3 further including a step wherein position saliency is normalized to a value from 0 to 1 in accordance with the following formula:
New value=1−absolute value ((current value−average value)/(maximum value−minimum value)).

7. The method of claim 4 further including a step wherein a new speed saliency is calculated in accordance with the following formula:
New speed saliency=speed saliency*(maximum speed saliency−minimum speed saliency).

8. The method of claim 1 further including the step of sorting the first priority list in descending order of interest value, Iᵢ.

9. The method of claim 8 further including the step of truncating the first priority list to include only units having a priority number above a predetermined number.

10. A computer implemented real-time strategy game adapted to construct and depict a series of interesting events during a simulation of variable duration comprising:
a interest manager module of code and a cinematics manager module of code;
a simulated environment;
a plurality of simulated units, each unit i of said units selected from the group consisting of:
environment units including planets, ground locations, buildings and objects capable of moving about in said environment;
combat units including relatively large ships, relatively mid-sized ships, relatively small ships and weapons placed on any of said combat units in positions fixed in relation to any particular ones of said combat units; and,
characters including infantry, heroes, pilots and non-combatants;
each unit i, of said plurality of units having at any one time during the simulation an interest value, Iᵢ;
a plurality of saliency characteristics j, for each said unit i, each of said plurality of saliency characteristics j selected from the group consisting of size, attack power, position, current health, number of targets that each said unit i is attacking and is attacked by and the speed of each said unit i, each saliency characteristic having a value, sⱼ for each unit i;
a weight value for each saliency characteristic j;
said interest manager module of code adapted to:
calculate at said time each interest value, Iᵢ, associated with each of the units i in accordance with the formula
Iᵢ=Σw(i)ⱼs(i)ⱼ,
where
w(i)ⱼ=weight value of each unit i's saliency characteristic j, and,
s(i)ⱼ=value of each characteristic of each unit i's saliency characteristic j;
create a priority listing of interest values from each said interest value, Iᵢ, calculated with said formula at said time; and
pick a most salient unit to be one of said units on a basis including the priority listing of interest values and adapted to send data associated with said most salient unit to said cinematics manager module of code;
said cinematics manager module of code adapted to
construct a single camera sequence for said most salient unit from a template camera shot sequence and randomly generated parameters selected from the group consisting of shot duration, camera position and camera orientation;
execute said sequence by generating key frames for camera position, orientation, target and zoom; and,
interpolate the key frames for the duration of said sequence.
